(19) United States
(12) Patent Application Publication
(10) Pub. No.: US 2012/0311474 A1
(43) Pub. Date: Dec. 6, 2012

(54) MAP-BASED METHODS OF VISUALIZING RELATIONAL DATABASES

(75) Inventors: Jonathan McPherson, Redmond, WA (US); Roderic Wells Lewis, JR., Maple Valley, WA (US)

(73) Assignee: Microsoft Corporation, Redmond, WA (US)

(21) Appl. No.: 13/152,251

(22) Filed: Jun. 2, 2011

(51) Int. Cl. G06F 17/30; G06F 3/048

(52) U.S. Cl. 715/771; 707/687; 707/E17.005

(57) ABSTRACT

Technologies are described herein for generating and manipulating visual maps of relational databases. A list of data tables is retrieved from the database and ordered according to the number of relationships for each data table. A database map is generated containing tiles corresponding to each data table in the list, wherein tiles corresponding to related data tables are adjacent along at least one edge or corner of the tiles where possible. The display attributes of each tile may be adjusted to reflect properties of the corresponding data table. The database map is then displayed to a user in a user interface, and controls are provided that allow the user to navigate and zoom the database map in the user interface in order to reveal data contained in the data tables corresponding to the displayed tiles.

### BACKGROUND

Relational databases are often used to implement data storage mechanisms for business applications where the data maps to real-world items, such as financial records, medical records, personal information, manufacturing and logistical data, and the like. For novice users, relational databases may be hard to visualize and understand. Traditional forms of exploring and querying relational databases focus on views of individual tables. As the relational database grows increasingly normalized, with the number of tables increasing and the number of human-readable columns in each table decreasing, it may become harder and harder to understand the database by looking at any table in isolation.

Traditional database visualization tools may allow users to create diagrams, such as an entity-relationship (“ER”) diagram, that show all the tables in the relational database, along with how those tables are related. Tables are drawn as boxes containing schema, and the relationships between tables are depicted as lines connecting the boxes. Markers on the lines or their endpoints may indicate the kind of relationship that the connected tables share. However, these diagrams may grow too complicated to understand for even a moderately sized relational database.

It is with respect to these considerations and others that the disclosure made herein is presented.

### SUMMARY

Technologies are described herein for generating and manipulating visual maps of relational databases. Utilizing the technologies described herein, a novel metaphor for database visualization may be implemented that visually depicts the tables in a relational database as a database map. The database map may be generated such that the tables in the database that are related to each other appear as close to each other as possible in the database map. In this way, tightly connected or related groups of tables may be displayed together in regions. This may offer an improvement over traditional ER diagrams, which generally force the user to hand-position the tables on the surface, or have a default positioning based on alphabetical order or some other simple metric.

In addition, while the tables are initially visualized as tiles containing the name of the table and/or other textual label, a user may be provided facilities to explore, search, and zoom the database map to explore the contents of the tables in the database. In this way, the first view provided to the user provides a high level overview of the objects and the way they are related, while allowing the user to reveal the underlying data as they desire. This may provide another improvement over traditional ER diagrams that often show so much detail that it is hard to get a big-picture view.

According to embodiments, a list of data tables is retrieved from a database and ordered according to the number of relationships for each data table. A database map is generated containing tiles corresponding to each data table in the list, wherein tiles corresponding to related data tables are adjacent along at least one edge or corner of the tiles, where possible. The display attributes of each tile may be adjusted to reflect properties of the corresponding data table. The database map is then displayed to a user in a user interface, and controls are provided that allow the user to navigate and zoom the database map in the user interface in order to reveal data contained in the data tables corresponding to the displayed tiles.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIGS. 2A-2C are screen diagrams showing an illustrative user interface for displaying and navigating database maps of relational databases, according to embodiments described herein;

FIG. 3 is a flow diagram showing one method for generating a database map of relational databases using a “space-dividing” layout, according to embodiments described herein;

FIG. 4 is an ER diagram showing a number of tables in an exemplary relational database, along with the relationships between the tables, according to embodiments described herein;

FIGS. 5A and 5B are block diagrams illustrating additional details regarding the generation of a database map of a relational database using the space-dividing layout, according to embodiments described herein;

FIG. 6 is a flow diagram showing another method for generating a database map of a relational database using an “edge-adhesion” layout, according to embodiments described herein;

FIGS. 7A and 7B are block diagrams illustrating additional details regarding the generation of the database map of the relational database using the edge-adhesion layout, according to embodiments described herein; and

FIG. 8 is a block diagram showing an illustrative computer hardware and software architecture for a computing system capable of implementing aspects of the embodiments presented herein.

### DETAILED DESCRIPTION

The following detailed description is directed to technologies for generating and manipulating visual maps of relational databases. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

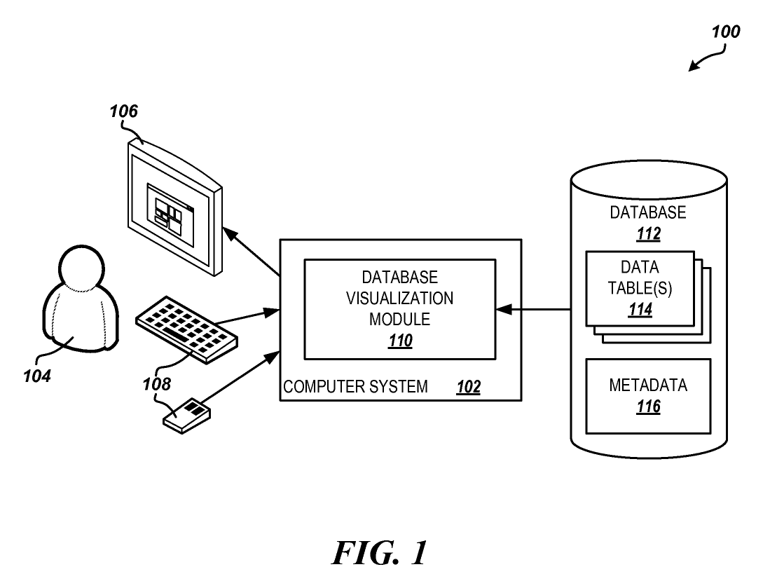

FIG. 1 shows an illustrative operating environment 100 including several software components for generating and manipulating visual maps of relational databases, according to embodiments provided herein. The environment 100 includes a computer system 102. The computer system 102 may represent a user computing device, such as a personal computer (“PC”), a desktop workstation, a laptop, a notebook, a mobile device, a personal digital assistant (“PDA”), and the like. Alternatively, the computer system 102 may represent a user computing device operatively connected to one or more application servers, Web servers, database servers, network appliances, dedicated hardware devices, and/or other server computers or user computing devices known in the art. The computer system 102 is accessed by a user 104 through a display device 106 and one or more input devices 108, such as a keyboard and/or mouse, as shown in FIG. 1.

According to embodiments, a database visualization module 110 executes on the computer system 102 that generates visual database maps from relational databases provides services to user 104 to navigate the database maps. The database visualization module 110 may execute locally on a user computing device of the computer system 102, or may execute on a server computer, such as a Web server, accessed by a client application executing on a user computing device. The database visualization module 110 may be implemented as hardware, software, or a combination of the two. The database visualization module 110 may be an add-in or component of a relational database management system (“RDBMS”), such as the MICROSOFT® ACCESS® database software from Microsoft Corp. of Redmond, Wash., and may include a number of application program modules and other components on the computer system 102.

The database visualization module 110 accesses a database 112 in order to generate the database maps. The database 112 may be a relational database or other data storage mechanism known in the art and contains a number of data tables 114 for storing data. The database 112 may also contain metadata 116 defining the structure or “schema” of the database, such as relationships between the data tables 114. According to one embodiment, the database visualization module 110 utilizes the metadata 116 to generate database maps representing the data tables 114 in the database 112 and displays the database maps to the user 104 on the display device 106, as will be described in more detail herein.

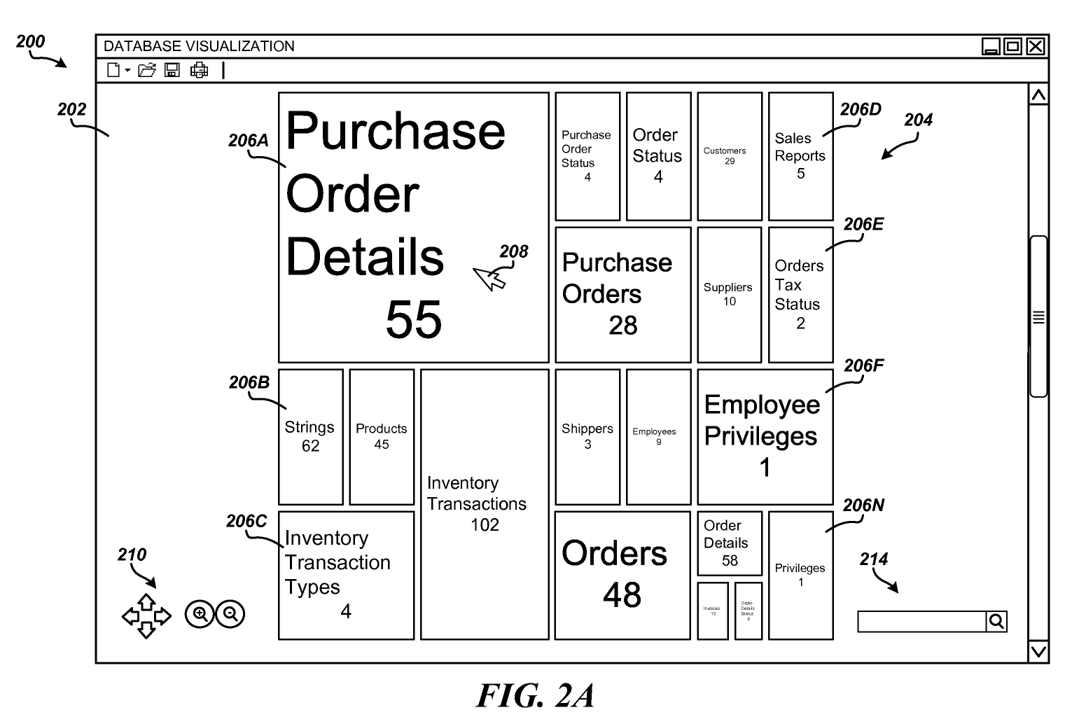

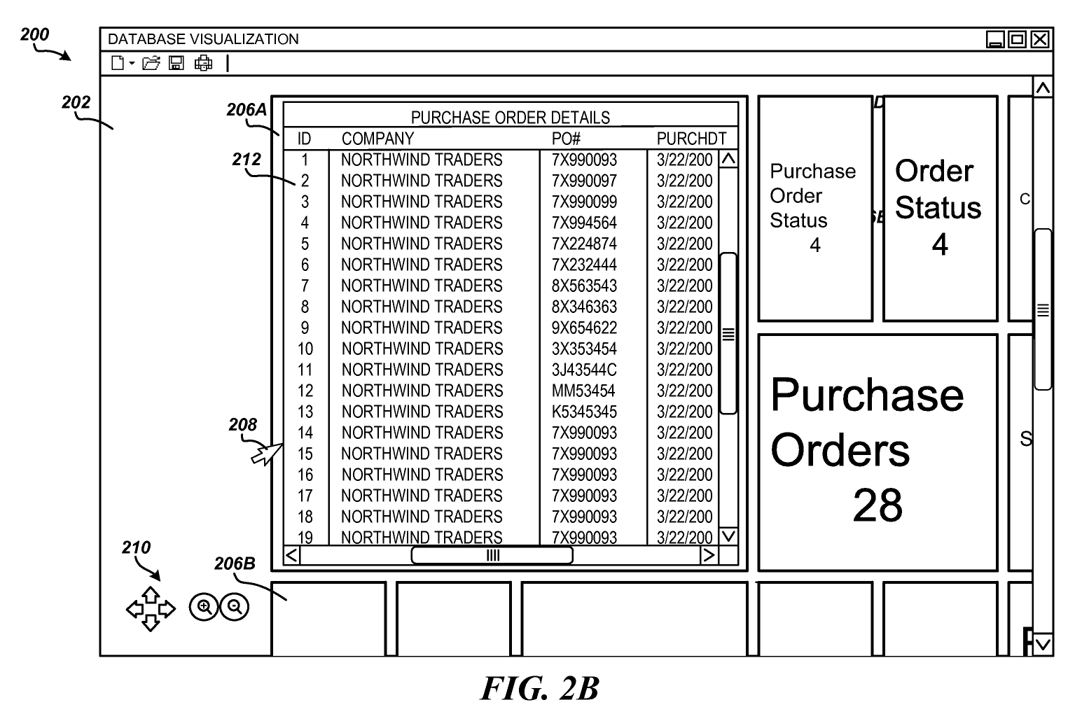

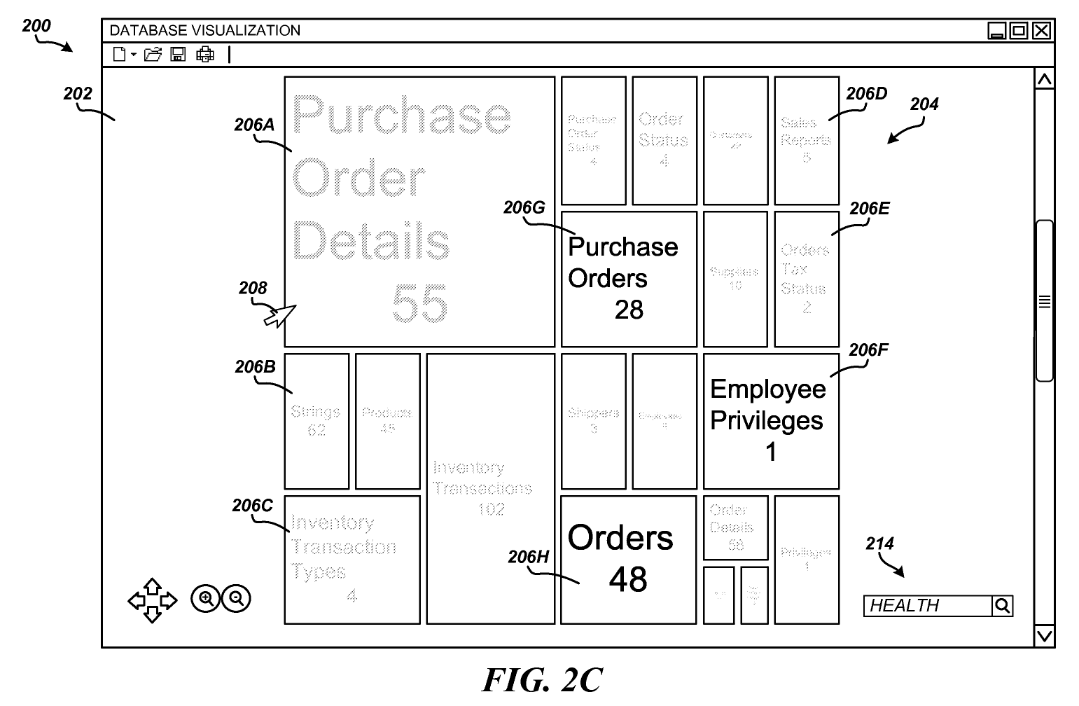

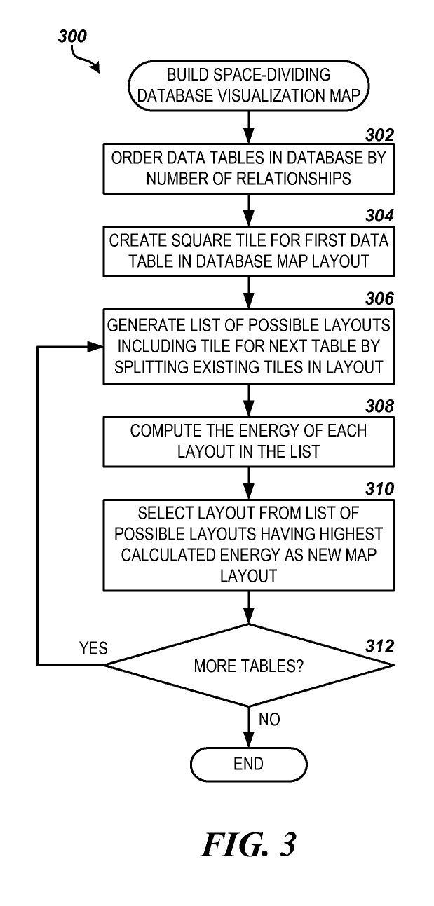

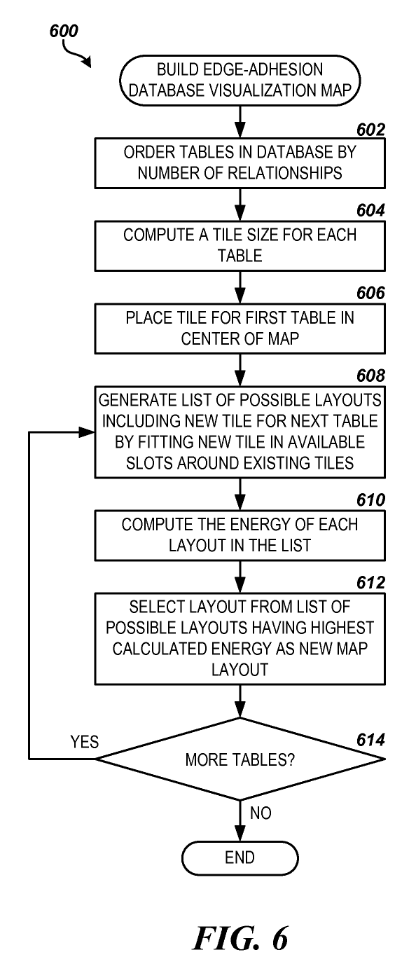

FIGS. 2A-2C show an example of an illustrative user interface 200 displayed by the database visualization module 110. The user interface 200 includes a window 202 in which a database map 204 is displayed. According to embodiments, the database map 204 includes a number of tiles 206A-206N (referred to herein generally as tiles 206), as shown in FIG. 2A. Each tile 206 corresponds to single object in the database 112, such as a data table 114. The tiles 206A-206N are arranged in the database map 204 according to relationships between the corresponding data tables 114, as will be described in more detail below in regard to FIGS. 3 and 6. The database visualization module 110 may determine the relationships between the data tables 114 from the metadata 116 in database 112 in order to generate the database map 204.

Each tile 206 may be labeled with an identifier of the corresponding data table 114, such as the table name as shown in FIG. 2A. The label of each tile may provide further information regarding the corresponding data table 114, such as the number of rows in the table. According to embodiments, the size of each tile 206 may relate a relative importance of the corresponding data table 114 in the database, the number of relationships for the data table, the number of records in the data table, or some combination of these, as will be described in more detail below. In addition, other attributes of each tile 206 may relate properties of the corresponding data table 114. For example, tiles 206 corresponding to data tables 114 with a relatively large number of relationships or records may be colored with a darker color, while tiles corresponding to tables with relatively fewer relationships or records may be colored with a lighter color. It will be appreciated that other attributes of each tile 206 may be adjusted by the database visualization module 110 to reflect other properties of the corresponding data table 114, including, but not limited to, the shading of the tile, the font used for the label of the tile, the thickness or quality of the border of the tile, and the like.

According to further embodiments, the database visualization module 110 may provide facilities that allow the user 104 to manipulate the database map 204. For example, the database visualization module 110 may provide a pointer control 208 allowing the user 104 to select a particular tile 206A corresponding to a data table 114 in the database 112, by manipulating the point control with a mouse, for example. The database visualization module 110 may also provide a set of navigation controls 210 that allows the user 104 to pan and zoom the database map 204 in the window 202.

According to one embodiment, if the database map 204 is zoomed to a zoom level such that a particular tile, such as tile 206A, exceeds a threshold size, the label on the tile may be replaced with a data grid 212 or other display showing the records in the corresponding data table 114 from the database 112, as shown in FIG. 2B. In another embodiment, double-clicking the particular tile 206A may cause the database visualization module 110 to both center the tile in the map and zoom the database map 204 to the appropriate zoom-level, while showing the data grid 212 containing records from the corresponding data table 114 in the tile 206A.

The database visualization module 110 may further provide a set of search controls 214 that allows the user 104 to search the database 112 for particular data. For example, the search controls 214 may allow a search string or keyword, such as “HEALTH,” to be entered. As the user 104 types characters in the search controls 214, the database visualization module 110 may search an index of words in the data tables 114 or the database 112. The database visualization module 110 may then highlight those tiles 206G-206H in the database map 204 corresponding to data tables 114 containing the search string or keyword, by changing the display attributes of the tiles, and or fading the those tiles 206 corresponding to data tables 114 that don't contain the searched-for data from view, as shown in FIG. 2C.

In one embodiment, when only one tile 206 remains highlighted in the database map 204, the user 104 may press a key on a keyboard to cause the database visualization module 110 to both center and zoom the database map 204 on the tile while showing the data grid 212 in the tile containing those records from the corresponding data table 114 including the searched-for data. It will be appreciated that other methods of searching the data in the database 112 known in the art may be implemented by the database visualization module 110 using the search controls 214.

Referring now to FIGS. 3 and 6, additional details will be provided regarding the embodiments presented herein. It should be appreciated that the logical operations described with respect to FIGS. 3 and 6 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof It should also be appreciated that more or fewer operations may be performed than shown in the figures and described herein. The operations may also be performed in a different order than described.

FIG. 3 illustrates one routine 300 for generating a database map 204 from the database 112 using a “space-dividing” layout, according to one embodiment. In the space-dividing layout, the database map 204 contains tiles 206 for each data table 114 in the database 112 while retaining an overall square shape. In addition, the relationships or “affinity” between the data tables 114 in the database 112 are reflected through the layout of the tiles 206 in the database map 204. According to one embodiment, the routine 300 is performed by the database visualization module 110 executing on the computer system 102 and/or other servers or computing devices. It will be appreciated that the routine 300 may also be performed by other modules or components executing on other computing devices, or by any combination of modules, components, and computing devices.

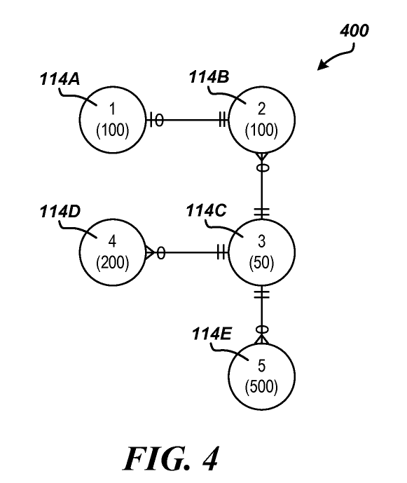

The routine 300 begins at operation 302, where the database visualization module 110 retrieves a list of data tables 114 from the database 112 and orders the list by the number of relationships each table has, from highest to lowest. The database visualization module 110 may determine the number of relationships for each data table 114 from the metadata 116 in the database 112 defining the schema of the data tables. For example, FIG. 4 shows a simplified entity-relationship (“ER”) diagram 400 for a database 112 containing five data tables 114A-114E with the indicated relationships. From the database 112 depicted in the ER diagram 400 in FIG. 4, the database visualization module 110 may generate the ordered list of tables shown below in Table 1.

TABLE 1
Ordered List of Tables

| Table | # of Relationships | # of Records |
|---|---|---|
| TABLE 3 | 3 | 50 |
| TABLE 2 | 2 | 100 |
| TABLE 1 | 1 | 100 |
| TABLE 4 | 1 | 200 |
| TABLE 5 | 1 | 500 |

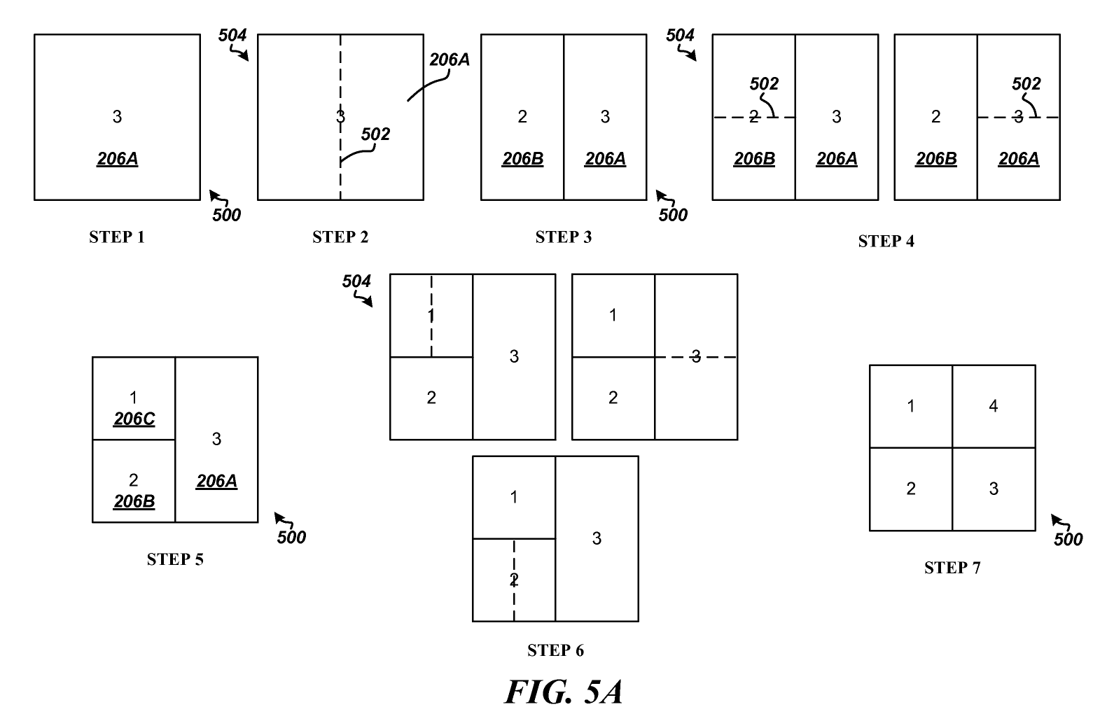

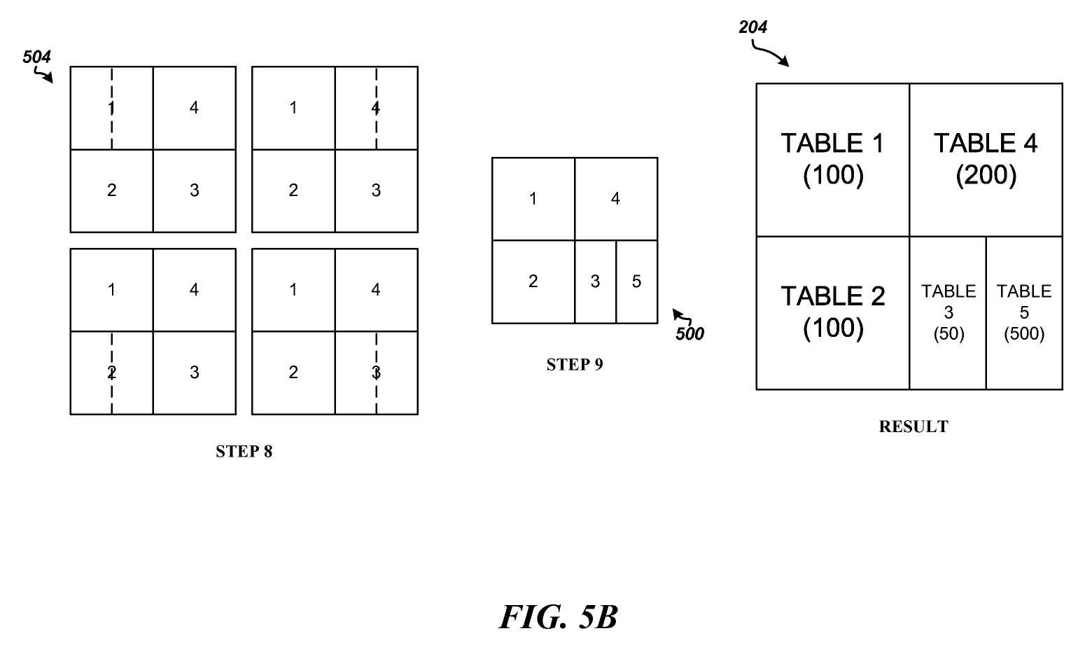

From operation 302, the routine 300 proceeds to operation 304, where the database visualization module 110 initially creates a square tile 206 in the database map 204 for the first data table 114 in the ordered list of tables. For example, the initial current layout 500 of the database map 204 may comprise the square tile 206A corresponding to table 3 114C, as shown at Step 1 in FIG. 5A. The routine 300 then proceeds from operation 304 to operation 306, where the database visualization module 110 generates a list of possible new layouts 504 for the database map 204 containing the next data table 114 in the ordered list of tables.

According to one embodiment, each layout in the list of possible new layouts 504 comprises an arrangement identical to the current layout 500 with one existing tile 206 split in two to create a new location for a new tile corresponding to the next data table 114 to be added. For example, as shown at Step 2 in FIG. 5A, the current tile 206A for table 3 114C is split, indicated by split line 502, creating two layouts for the list of possible new layouts for adding a new tile for table 2 114B to the database map 204. In one embodiment, a split of an existing tile 206 will be either horizontal such as to result in two square tiles, or vertical such as to result in two upright rectangles, i.e. rectangles that are taller than they are wide, as shown by the split indicated by split line 502 of tile 206A at Step 2 in FIG. 5A.

From operation 306, the routine 300 proceeds to operation 308, where the database visualization module 110 computes an “energy” for each layout in the list of possible new layouts 504 quantifying the ability of the layout to visually reflect the affinity of the data tables 114 in the database map 204. According to one embodiment, the energy of each layout represents the total number of pixels or other units along an edge of each tile 206 that touches another tile corresponding to a data table 114 to which the data table corresponding to the first tile is related in the database 112. Next, at operation 310, the database visualization module 110 selects the layout from the list of possible new layouts 504 having the highest computed energy as the new current layout 500 for the database map 204. For example, from the two possible new layouts shown at Step 2 in FIG. 5A, the database visualization module 110 may select the layout 500 shown at Step 3, containing the split tile 206A corresponding to data table 3 114C along with the new tile 206B corresponding to data table 2 114B from the ordered list of data tables

The routine 300 proceeds from operation 310 to operation 312, where the database visualization module 110 determines if more data tables 114 exist in the ordered list of tables to be added to the database map 204. If more data tables 114 exist, the routine 300 returns to operation 306, where the database visualization module 110 generates a new list of possible new layouts 504 for the database map 204 containing a tile for the next data table, such as data table 1 114A, in the ordered list of tables, as shown at Step 4 in FIG. 5A. From the new list of possible new layouts 504, the database visualization module 110 selects the layout containing a tile 206C for the next data table 114A having the highest computed energy as the new current layout 500, as described above in regard to operations 308 and 310, and as shown at Step 5 in FIG. 5A. The operations 306 through 310 continue iteratively for the remaining data tables in the ordered list of tables, as depicted at Steps 6 and 7 in FIG. 5A for data table 4 114D and Steps 8 and 9 in FIG. 5B for data table 5 114E.

If at operation 312, the database visualization module 110 determines that no more data tables 114 exist in the ordered list of tables to be added to the database map 204, then the routine 300 ends. It will be appreciated that, by applying the space-dividing layout routine 300 described above to the database 112 depicted in the ER diagram 400 in FIG. 4, the database visualization module 110 may generate a resulting database map 204 similar to that shown at Result in FIG. 5B. The database visualization module 110 may then display the generated database map 204 to the user 104 in the user interface 200 described above in regard to FIGS. 2A-2C.

FIG. 6 illustrates another routine 600 for generating a database map 204 from the database 112 using an “edge-adhesion” layout, according to another embodiment. In the edge-adhesion layout, in addition to reflecting the affinity of the data tables 114 in the database 112 through the layout of the tiles 206, the relative size of each tile in the database map 204 may relate properties of the corresponding data table. For example, the relative width of the tile 206 may relate the number of relationships for the corresponding data table 114, while the relative height of the tile may relate the number of records in the table. According to one embodiment, the routine 600 is performed by the database visualization module 110 executing on the computer system 102 and/or other servers or computing devices. It will be appreciated that the routine 600 may also be performed by other modules or components executing on other computing devices, or by any combination of modules, components, and computing devices.

The routine 600 begins at operation 602, where the database visualization module 110 retrieves a list of data tables 114 from the database and orders the list by the number of relationships each table has, from highest to lowest. As will be seen below, this ordering of the data tables 114 may result in the generation of a database map 204 with those data tables 114 with the most relationships at or near the center of the map. As described above in regard to operation 302, the database visualization module 110 may determine the number of relationships for each data table 114 from the metadata 116 in the database 112 defining the schema of the data tables. Using the example database 112 depicted in the ER diagram 400 in FIG. 4, the database visualization module 110 may generate the ordered list of tables shown above in Table 1.

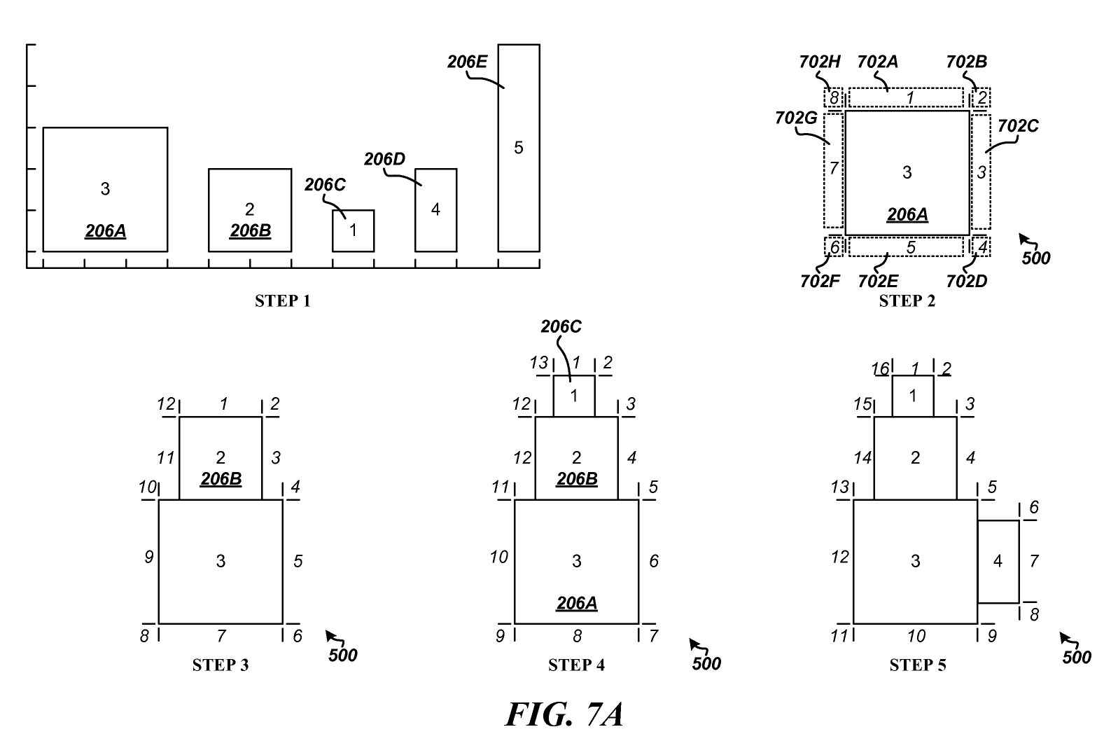

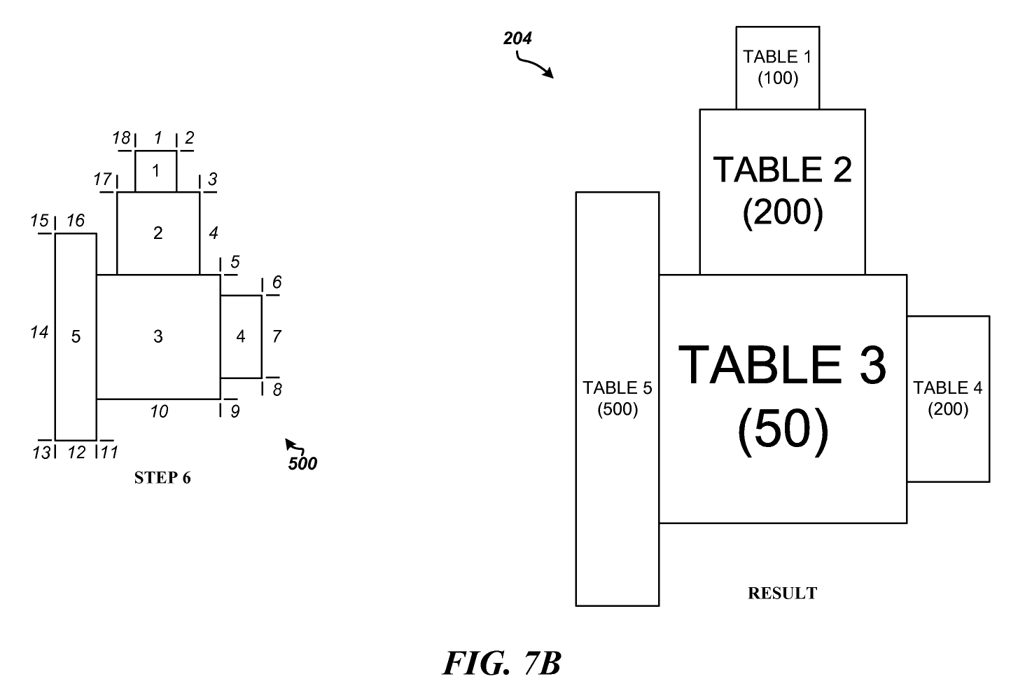

From operation 602, the routine 600 proceeds to operation 604, where the database visualization module 110 computes a relative size for each tile 206A-206E corresponding to each data table 114A-114E in the ordered list of tables. According to one embodiment, the database visualization module 110 computes the width of each tile 206 from the relative number of relationships for the corresponding data table 114, and the height of the tile from the number of records in the corresponding data table in relation to the number of records in other data tables in the list. In addition, the database visualization module 110 may ensure that no tile 206 is wider than it is high by increasing the height of the tile to be at least the width of the tile, as necessary. It will be appreciated that this will result in the tiles 206 in the database map 204 generated according to the edge-adhesion layout being either squares or upright rectangles. For example, from the data tables 114 in the ordered list of tables shown above in Table 1, the database visualization module 110 may generate corresponding tiles 206A-206E with the relative heights and widths shown at Step 1 in FIG. 7A for inclusion in the database map 204.

In further embodiments, some other combination of number of relationships, number of records, number of unique keys, or other properties of the data tables 114 in the database 112 may be utilized by the database visualization module 110 in computing the relative width and/or height of each tile 206 for the database map 204. Next, at operation 606, the database visualization module 110 places the tile 206 corresponding to the first data table 114 in the ordered list of data tables in the center of the database map 204. For example, the initial current layout 500 of the database map 500 may comprises the tile 206A corresponding to data table 3 114C, as shown at Step 2 in FIG. 7A.

The routine 600 proceeds from operation 606 to operation 608, where the database visualization module 110 generates a list of possible new layouts for the database map 204 containing the tile 206 corresponding to the next data table 114 in the ordered list of tables. In order to generate the list of possible new layouts, the database visualization module 110 may create a list of slots 702A-702H (referred to herein generally as slot 702) around the tiles in the current layout 500. A slot 702 may be created at each open edge and corner of the existing tiles 206 in the layout. For example, from the initial tile 206A placed in the database map 204, the database visualization module 110 may generate a list of eight slots 702A-702H, as shown at Step 2 in FIG. 7A.

It will be appreciated that the numbering of the available slots 702 around the existing tiles 206 in the current layouts 500 shown in FIGS. 7A and 7B is shown for illustrative purposes only and that the slots may be numbered in a different order or direction than shown. In addition, more or fewer slots 702 may be identified by the database visualization module 110 than is shown in the figures and described herein. According to one embodiment, the list of possible new layouts comprises the current layout 500 with the tile 206 corresponding to the next data table 114 in the ordered list of tables fitted into each open slot 702, such that the new tile does not overlap any existing tiles in the layout. For example, for the tile 206B corresponding to the next data table, data table 2 114B, in the ordered list of tables, the list of possible new layouts may comprise the tile 206A initially place in the database map 204 with the tile 206B placed in each of the eight enumerated slots 702A-702H.

From operation 608, the routine 600 proceeds to operation 610, where the database visualization module 110 computes an energy for each layout in the list of possible new layouts. According to one embodiment, the energy of each layout represents the sum of the inverse of the distances between the center of the newly fitted tile 206 and those tiles corresponding to a data table 114 to which the data table corresponding to the new tile is related in the database 112. Next, at operation 612, the database visualization module 110 selects the layout from the list of possible new layouts having the highest computed energy as the new current layout 500 for the database map 204. For example, from the eight possible layouts corresponding to tile 206B in each of slots 702A-702H shown at Step 2 in FIG. 7A, the database visualization module 110 may select the layout 500 shown at Step 3, containing the new tile 206B corresponding to data table 2 114B in the ordered list of tables located adjacent to tile 206A in slot 1 702A.

The routine 600 proceeds from operation 612 to operation 614, where the database visualization module 110 determines if more tiles 206 corresponding to data tables 114 in the ordered list of tables exist to be added to the database map 204. If more tiles 206 exist, the routine 600 returns to operation 606, where the database visualization module 110 creates a new list of slots around the existing tiles in the current layout 500, as shown at Step 3 in FIG. 7A, and then generates a new list of possible new layouts for the database map 204 containing the tile 206C corresponding to the next data table, data table 1 114A, in the ordered list of tables. From the new list of possible new layouts, the database visualization module 110 selects the layout containing the tile 206C having the highest computed energy as the new current layout 500, as described above in regard to operations 610 and 612, and as shown at Step 4 in FIG. 7A. The operations 606 through 612 continue iteratively for the tiles 206 corresponding to the remaining data tables in the ordered list of tables, as depicted at Step 5 in FIG. 7A for data table 4 114D and Step 6 in FIG. 7B for data table 5 114E.

If at operation 614, the database visualization module 110 determines that no more tiles 206 corresponding to data tables 114 in the ordered list of tables exist to be added to the database map 204, then the routine 600 ends. It will be appreciated that, by applying the edge-adhesion layout routine 600 described above to the database 112 depicted in the ER diagram 400 in FIG. 4, the database visualization module 110 may generate a resulting database map 204 similar to that shown at Result in FIG. 7B. The database visualization module 110 may then display the generated database map 204 to the user 104 in the user interface 200 described above in regard to FIGS. 2A-2C.

While the present disclosure describes the generation of the database map 204 using square or rectangular tiles 206, it will be appreciated that other polygons may be utilized by the database visualization module 110 for generating the tiles corresponding to each data table 114 depicted in the database map, including, but not limited to, triangles, hexagons, and octagons. In a further embodiment, the database visualization module 110 may place an amount of space between adjacent tiles 206 in the database map 204 such that the relationship, if any, between the data tables 114 corresponding to the adjacent tiles can be shown in the space, using conventional ER diagramming notation, for example.

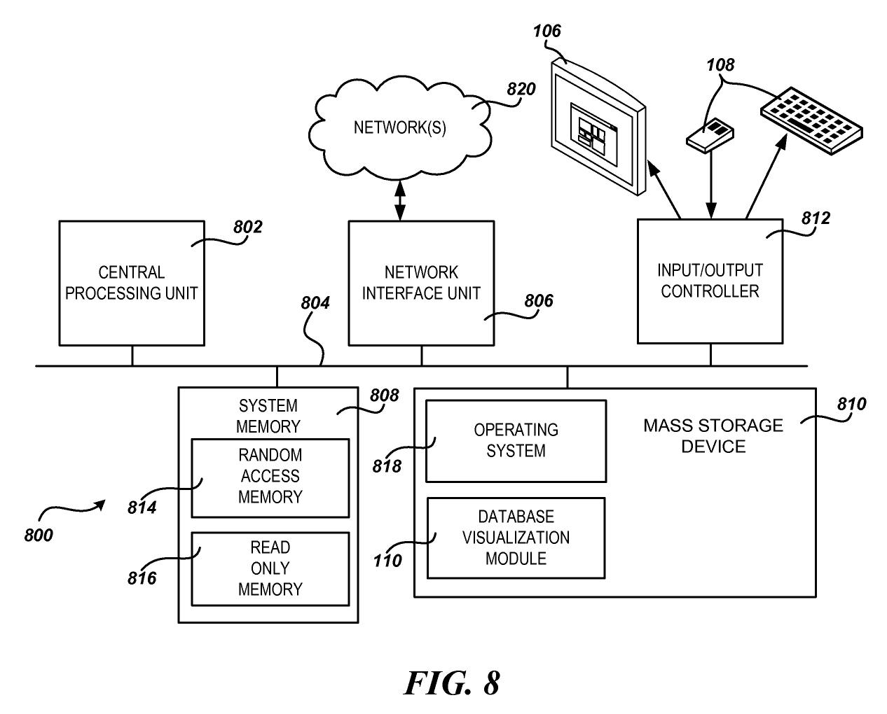

FIG. 8 shows an example computer architecture for a computer 800 capable of executing the software components described herein for generating and manipulating visual maps of relational databases, in the manner presented above. The computer architecture shown in FIG. 8 illustrates a conventional desktop computer, laptop, notebook, PDA, wireless phone, server computer, or other computing device, and may be utilized to execute any aspects of the software components presented herein described as executing on the computer system 102 or other computing device.

The computer architecture shown in FIG. 8 includes one or more central processing units (“CPUs”) 802. The CPUs 802 may be standard processors that perform the arithmetic and logical operations necessary for the operation of the computer 800. The CPUs 802 perform the necessary operations by transitioning from one discrete, physical state to the next through the manipulation of switching elements that differentiating between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 808, including a random access memory (“RAM”) 814 and a read-only memory 816 (“ROM”), and a system bus 804 that couples the memory to the CPUs 802. A basic input/output system containing the basic routines that help to transfer information between elements within the computer 800, such as during startup, is stored in the ROM 816. The computer 800 also includes a mass storage device 810 for storing an operating system 122, application programs, and other program modules, which are described in greater detail herein.

The mass storage device 810 is connected to the CPUs 802 through a mass storage controller (not shown) connected to the bus 804. The mass storage device 810 provides non-volatile storage for the computer 800. The computer 800 may store information on the mass storage device 810 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 800 may store information to the mass storage device 810 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 800 may further read information from the mass storage device 810 by detecting the physical states or characteristics of one or more particular locations within the mass storage device.

As mentioned briefly above, a number of program modules and data files may be stored in the mass storage device 810 and RAM 814 of the computer 800, including an operating system 818 suitable for controlling the operation of a computer. The mass storage device 810 and RAM 814 may also store one or more program modules. In particular, the mass storage device 810 and the RAM 814 may store the database visualization module 110, which was described in detail above in regard to FIG. 1. The mass storage device 810 and the RAM 814 may also store other types of program modules or data.

In addition to the mass storage device 810 described above, the computer 800 may have access to other computer-readable media to store and retrieve information, such as program modules, data structures, or other data. It should be appreciated by those skilled in the art that computer-readable media may be any available media that can be accessed by the computer 800, including computer-readable storage media and communications media. Communications media includes transitory signals. Computer-readable storage media includes volatile and non-volatile, removable and non-removable media implemented in any method or technology for the storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 800.

The computer-readable storage medium may be encoded with computer-executable instructions that, when loaded into the computer 800, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 800 by specifying how the CPUs 802 transition between states, as described above. According to one embodiment, the computer 800 may have access to computer-readable storage media storing computer-executable instructions that, when executed by the computer, perform the routines 300 and 600 for generating database maps from relational databases, described above in regard to FIGS. 3 and 6.

According to various embodiments, the computer 800 may operate in a networked environment using logical connections to remote computing devices and computer systems through one or more networks 820, such as a LAN, a WAN, the Internet, or a network of any topology known in the art. The computer 800 may connect to the network 820 through a network interface unit 806 connected to the bus 804. It should be appreciated that the network interface unit 806 may also be utilized to connect to other types of networks and remote computer systems.

The computer 800 may also include an input/output controller 812 for receiving and processing input from a number of input devices 108, including a keyboard, a mouse, a touchpad, a touch screen, an electronic stylus, or other type of input device. Similarly, the input/output controller 812 may provide output to a display device 106, such as a computer monitor, a flat-panel display, a digital projector, a printer, a plotter, or other type of output device. It will be appreciated that the computer 800 may not include all of the components shown in FIG. 8, may include other components that are not explicitly shown in FIG. 8, or may utilize an architecture completely different than that shown in FIG. 8.

Based on the foregoing, it should be appreciated that technologies for generating and manipulating visual maps of relational databases are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for generating a database map depicting a plurality of data tables in a database, the method comprising executing instructions in a computer system to perform the operations of:
retrieving a list of the plurality of data tables from the database;
determining a relative size and location in the database map of a first tile corresponding to a first data table of the plurality of data tables, wherein the first tile comprises a polygon and the location of the first tile is determined such that at least one edge or corner of the first tile is adjacent to a second tile in the database map corresponding to another of the plurality of data tables that is related to the first data table; and
displaying the database map in a user interface, wherein the user interface comprises one or more controls allowing a user to navigate and zoom the database map in order to reveal data contained in the first data table corresponding to the first tile.

2. The computer-implemented method of claim 1, further comprising, upon the database map being zoomed to a zoom level such that the first tile exceeds a threshold size, showing a data grid in the first tile containing data records from the corresponding first data table.

3. The computer-implemented method of claim 1, wherein the one or more controls comprises search controls allowing the user to search for specified data in the plurality of data tables, and wherein tiles in the database map corresponding to data tables containing the specified data are highlighted in the user interface.

4. The computer-implemented method of claim 1, wherein the relative size of the first tile is determined from properties of the corresponding first data table.

5. The computer-implemented method of claim 4, wherein a relative width of the first tile corresponds to a number of relationships between the first data table and other data tables in the database.

6. The computer-implemented method of claim 4, wherein a relative height of the first tile corresponds to a number of records contained in the first data table.

7. The computer-implemented method of claim 1, wherein the polygon comprises one of a square or an upright rectangle.

8. The computer-implemented method of claim 1, wherein the database map comprises a square shape.

9. The computer-implemented method of claim 1, wherein tiles corresponding to the data tables having a highest number of relationships are located near a center of the database map.

10. The computer-implemented method of claim 1, wherein display attributes of the first tile in the database correspond to properties of the corresponding first data table in the database.

11. A computer-readable storage medium encoded with computer-executable instructions that, when executed by a computer, cause the computer to:
retrieve a list of data tables from a database;
order the list of data tables according to a number of relationships for each data table in the list;
place a first tile in a current layout of a database map corresponding to a first data table in the list of data tables having a greatest number of relationships;
generate a list of possible layouts of the database map including a new tile corresponding to a next data table in the list of data tables, where each possible layout in the list of possible layouts comprises the current layout with one existing tile split to create a location for placement of the new tile;
compute an energy for each of the possible layouts in the list of possible layouts;
select the possible layout from the list of possible layouts having a greatest energy as the current layout of the database map;
determine if more data tables exist in the list of data tables for placement of corresponding tiles in the database map; and
upon determining that more data tables exist in the list of data tables for placement of corresponding tiles in the database map, repeat the generate, compute, and select operations until no more data tables exists in the list of data tables for placement of corresponding tiles in the database map.

12. The computer-readable storage medium of claim 11, wherein computing the energy for each of the possible layouts comprises determining a total number of units along an edge of each tile in the database map that touches another tile corresponding to a data table to which the data table corresponding to the tile is related in the database.

13. The computer-readable storage medium of claim 11, wherein an existing tile in a possible layout may be split horizontally such as to result in two square tiles or vertically such as to result in two upright rectangles.

14. The computer-readable storage medium of claim 11, wherein the database map comprises a square shape.

15. The computer-readable storage medium of claim 11, encoded with further computer-executable instructions that cause the computer to display the database map in a user interface, wherein the user interface comprises one or more controls allowing a user to navigate and zoom the database map in order to reveal data contained in the data tables corresponding to the tiles in the database map.

16. A system for generating a database map from a database, the system comprising:
a computer; and
a database visualization module executing on the computer and configured to
retrieve a list of data tables from the database,
order the list of data tables according to a number of relationships for each data table in the list,
compute a relative size for a tile corresponding to each data table in the list of data tables,
place the tile corresponding to a first data table in the list of data tables having a greatest number of relationships in a center of a current layout of the database map,
generate a list of possible layouts of the database map including the tile corresponding to a next data table in the list of data tables, wherein each possible layout in the list of possible layouts comprises the current layout with the tile corresponding to the next data table fitted into one of a number of slots located on edges and corners of existing tiles in the current layout,
compute an energy for each of the possible layouts in the list of possible layouts,
select the possible layout from the list of possible layouts having a greatest energy as the current layout of the database map,
determine if more data tables exist in the list of data tables for placement of corresponding tiles in the database map, and
upon determining that more data tables exist in the list of data tables for placement of corresponding tiles in the database map, repeat the generate, compute, and select operations until no more data tables exists in the list of data tables for placement of corresponding tiles in the database map.

17. The system of claim 16, wherein computing the energy for each of the possible layouts comprises computing a sum of an inverse of distances between centers of the tile corresponding to the next data table and those tiles corresponding to a data table to which the next data table is related in the database.

18. The system of claim 16, wherein a relative width of a tile is computed from a number of relationships between the corresponding data table and other data tables in the database, and a relative height of the tile is computed from a number of records contained in the corresponding data table.

19. The system of claim 18, wherein the relative height for the tile is at least as large as the relative width computed for the tile.

20. The system of claim 16, wherein the database visualization module is further configured to display the database map in a user interface, wherein the user interface comprises one or more controls allowing a user to navigate and zoom the database map in order to reveal data contained in the data tables corresponding to the tiles in the database map.
